(19) United States
(12) Patent Application Publication
(10) Pub. No.: US 2006/0102863 A1
(43) Pub. Date: May 18, 2006

(54) Vacuum closure with linear drive unit

(75) Inventors: Stefan Bangert, Steinau (DE); Michael Konig, Frankfurt am Main (DE); Ralph Lindenberg, Budingen (DE); Uwe Schussler, Aschaffenburg (DE); Tobias Stolley, Frankfurt am Main (DE); Frank Fuchs, Geiselbach (DE)

Correspondence Address: KODA & ANDROLIA, 2029 CENTURY PARK EAST, SUITE 1140, LOS ANGELES, CA, 90067, US

(73) Assignee: Applied Films GmbH & Co. KG

(21) Appl. No.: 11/143,822

(22) Filed: Jun. 2, 2005

(30) Foreign Application Priority Data
Jun. 3, 2004 (EP) 04 013 151.8

(51) Int. Cl. F16K 11/074

(52) U.S. Cl. 251/129.11

(57) ABSTRACT

This invention relates to a vacuum treatment installation and a device therefor for the tight, especially vacuum-tight closing of an aperture, in particular a slit-like or rectangular aperture with a length that is preferably a multiple of the width of the aperture, in particular for a lock arrangement of a vacuum treatment installation, said device having a closure member (2) and for said closure member a linear drive unit (3,4,5) which, by way of a translational movement, can move the closure member from an open position into a closed position, said closure member having a sealing surface which is disposed in a plane (16) and which, in the closed position, makes sealing contact with a counter-sealing surface on the aperture side, and said plane running perpendicular to the direction of the translational movement (14) and at an oblique angle to the aperture normal (13).

This invention relates to a device for the tight, especially vacuum-tight closing of an aperture, in particular a slit-like or rectangular aperture with a length that is preferably a multiple of the width of the aperture, in particular for a lock arrangement of a vacuum treatment installation, said device having a closure member and for said closure member a linear drive unit which, by way of a translational movement, can move the closure member from an open position into a closed position. The invention relates additionally to a corresponding vacuum installation.

In vacuum treatment installations for the continuous coating of large-area plate-like substrates such as architectural glass, the substrates have to be transported from one coating zone to the next without there being any atmospheric exchange between the coating zones. To this end, provision is made, for example, of slit-like locks or transfer passages that have a long, narrow aperture through which the substrates can be moved. In order that individual zones of the vacuum treatment installation can be partitioned off in completely vacuum-tight manner, e.g. for maintenance purposes or in the entrance or exit zones of the transfer passage, closure means or so-called valves are provided at the slit-like or rectangular substrate-transport apertures. These valves must not only be able to close off the apertures—which are large with respect to their length—tightly, especially in vacuum-tight manner, but must also be able to do so quickly and without generating additional contamination. This, however, is where the problem lies.

With prior-art valves or closure means, the aperture is usually closed off by swinging the valve flap into position and then locking it. The reverse procedure is used to open the aperture. Because both valve or closure flap and, additionally, the locking member have to be moved, the opening or closing process requires a certain amount of time. In addition, a plurality of relative movements takes place at the sealing surfaces, firstly generating abraded particles and secondly impairing the service life.

A closure mechanism requiring only a linear movement for opening and closing is known from the U.S. Pat. No. 5,909,867, but this device needs a closure member with a complex geometry.

The object of this invention is thus to provide a vacuum valve or closure means for an aperture of the kind described above, especially a slit-like or rectangular aperture, which valve or closure means can be operated fast and “cleanly” without generation of unnecessary foreign matter, especially in the evacuated zone, and which has a simple geometry, is easy to maintain, and has a long service life.

This object is established by means of a device having the features of claim 1 and a vacuum treatment installation according to claim 10. Useful embodiments constitute the subject matter of the dependent claims.

The invention is based on awareness of the fact that a valve or closure means in which the closure member or valve disc is of simple geometric design can be moved fast by means of a linear translational movement if the sealing surface is oblique, especially defining an angle in the range from 20° to 60°, preferably 25° to 45°, with the normal to the aperture and, in particular, with the substrate transport direction, and is engineered to run transversely, especially at right angles, to the direction of linear motion. In this case a simple geometry can be selected for the closure member, with a sealing surface in a single plane; in the simplest of cases, a planar valve disc can be chosen. As a result of the oblique arrangement of the sealing surface or valve seat, a multiplicity of different closure-member movements can be avoided. In addition, this arrangement permits transport through the aperture along the normal thereto. Furthermore, there is a sufficiently large area for configuring the sealing surface in a single plane.

In order to configure the sealing surface obliquely with respect to the normal to the aperture, the normal being perpendicular to the plane of the aperture, it is of advantage to provide an assembly at the aperture to be closed, which assembly effects the oblique position of the sealing and counter-sealing surfaces. To this end, the aperture is preferably extended via the assembly by a channel, thus permitting provision on the assembly of a counter-sealing surface that runs at an angle to the channel and hence to the aperture to be closed, against which counter-sealing surface the closure member can be moved by linear motion.

On account of the purely linear motion between sealing and counter-sealing surfaces and the sealing means provided there, attrition and hence contamination of the evacuated zone is reduced, as also the wear.

In order to prevent contamination from the linear-movement unit from getting into the vacuum installation when the closure means is used in a vacuum treatment installation of the kind mentioned at the beginning, the major part of the linear-movement unit, and especially the components that make moving contact with each other, is mounted outside the evacuated zone. To this end, the linear-movement unit is provided with a housing component that can be attached in vacuum-tight manner to a vacuum-chamber wall. Only a lifting rod on which the closure member (valve disc) is mounted extends through the housing component into the evacuated zone. The lifting rod and the housing component are sealed off from each other by a flexible sealing member such as a diaphragm/bellows, which can accordingly be attached firmly and immovably to the lifting rod and to the housing component. This measure, too, prevents undesirable attrition caused by contact between moving components.

On account of the great length of the opening and hence of the closure member, it is of course possible to provide a plurality of lifting rods or linear-movement units along the length of the closure member. In particular, it is possible to provide just one drive but a plurality of lifting rods and corresponding transmission units for connecting the lifting rods with the drive.

The transmission units are preferably engineered to be self-locking, e.g. worm gearings, so that a reliable closure—also against pressure, e.g. atmospheric pressure relative to vacuum—is ensured also in the non-driven state. As a result, the closure means can also be used independently of the sealing direction.

Further advantages, characteristics and features of this invention are apparent from the following, detailed description of an embodiment, with reference to the enclosed, purely schematic drawings.

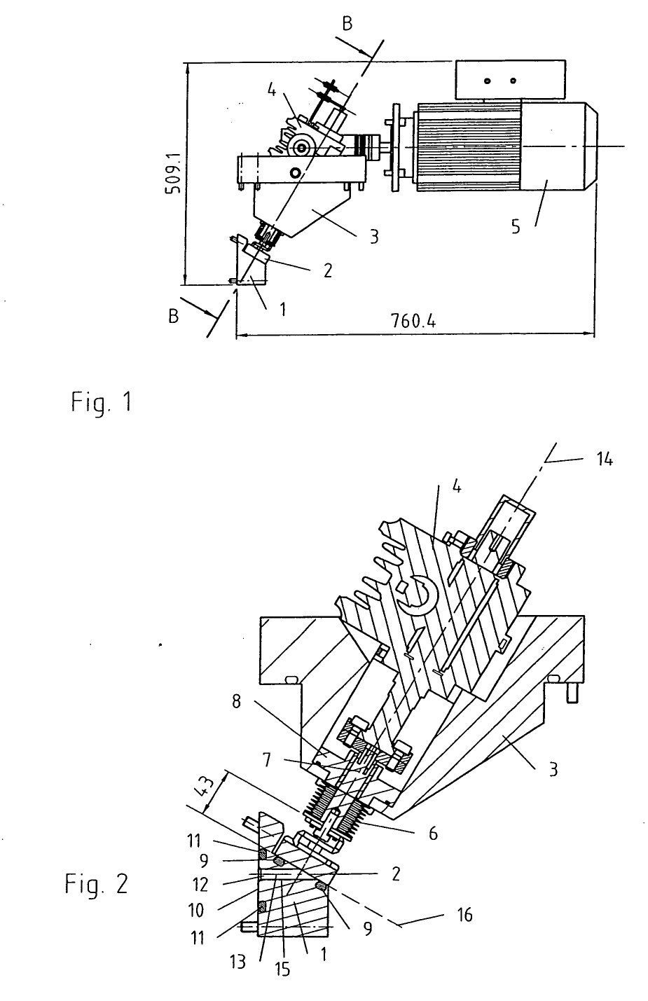

FIG. 1 shows a side view of the device according to the invention;

FIG. 2 shows a cut view through a device according to FIG. 1;

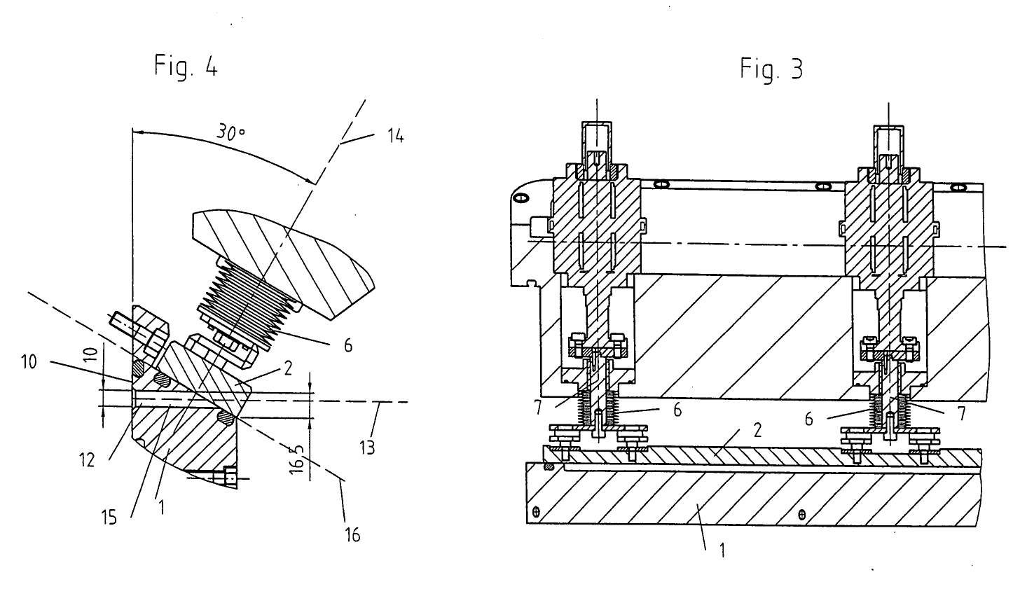

FIG. 3 shows a cut view along the line B-B from FIG. 1; and

FIG. 4 shows a detail of the cut view from FIG. 2.

FIG. 1 illustrates a device according to the invention for the vacuum-tight closing of a slit-like aperture in a vacuum treatment installation, said device comprising an electric motor 5, a transmission 4, a housing component 3, a closure member 2 and a counter-sealing-surface assembly 1.

As is apparent from FIG. 2, a channel 15 is provided in the counter-sealing-surface assembly 1, which channel can be closed off by the closure member 2. The counter-sealing-surface assembly 1 has a contact surface 10 with which the counter-sealing-surface assembly 1 is positioned at the aperture to be closed. The cross-section of the channel 15 parallel to the contact surface 10, or, expressed differently, the channel aperture 12 at the contact surface 10, matches the aperture to be closed off. The aperture extends longitudinally perpendicular to the plane of the drawing, and the length is a multiple of the visible width. A groove that surrounds the channel aperture 12 and accommodates an O-ring 11 is provided in the contact surface 10 so that the counter-sealing-surface assembly 1 can be brought into vacuum-tight contact with the aperture to be closed off. The longitudinal axis 13 of the channel 15 corresponds with the normal to the aperture.

The counter-sealing surface of the counter-sealing-surface assembly 1 is formed by the contact surface with the closure member 2 along the plane 16, the closure member, for its part, having a corresponding sealing surface. In the counter-sealing surface, an O-ring-typc scal 9 that surrounds the aperture zone of channel 15 is provided in a corresponding groove. The aperture to be closed off can thus be closed off in vacuum-tight manner by pressure of the closure member 2, along the plane 16, against the counter-sealing-surface assembly 1.

To open the aperture, the closure member 2 simply needs to be raised by way of a translational movement, i.e. a linear movement. To this end, a linear drive unit is provided that comprises the electric motor 5, the transmission 4 for converting the rotary motion of the electric motor 5 into linear motion, and the housing component 3 in which a lifting rod 7 moves to which the closure member 2 is attached. The housing component 3 is also provided with a guide member 8 in which the lifting rod 7 is slidably mounted.

The motion of the electric motor 5, converted to linear motion by the transmission, causes the lifting rod 7 to move up and down along the longitudinal axis 14, so that the aperture to be closed can be opened and closed by the closure member 2. On account of the motion being purely linear, the stress on the O-ring 9 is minimal, thus ensuring a long service life. What is more, the linear motion can be executed very fast and is also largely free of any vibration.

To further facilitate operation under vacuum conditions, a bellows 6 is attached to the lifting rod 7. The other end of the bellows is mounted on the housing component 3. The bellows 6 ensures a vacuum-tight connection between the lifting rod 7 and the housing component 3. Since the housing component 3 is still configured such that it can be attached in vacuum-tight manner to a vacuum chamber or the like, most of the linear drive unit can be mounted outside the evacuated zone. The advantage of this is that the majority of parts need not be of a kind suited for working under vacuum, and also that no unnecessary contamination caused by abraded particles or the like can get into the system, since all the components of the linear drive unit that make moving contact with each other, for example the lifting rod 7 and the guide element 8, or the transmission 4, are located outside the evacuated zone.

As is apparent from FIG. 3, which shows a cut view along the line B-B from FIG. 1, it is advantageous to provide a plurality of lifting rods 7, transmissions 4 and/or electric motors 5 along the length of the closure member, the length of said closure member depending on the length of the aperture to be closed and being of a magnitude greater than 1000 mm, in particular greater than 1500 mm. It is preferable to connect one drive via appropriate transmission arrangements to a plurality of lifting rods.

FIG. 4 shows in detail how the counter-sealing surface is arranged along the plane 16 at an oblique angle to the channel 15, and how the closure member 2 is mounted transversely to the direction of linear motion 14. In the embodiment shown, the angle between the contact surface 10 and the direction of linear motion 14 is 30°, which means the angle between the direction of linear motion 14 and the aperture normal 13 is 60°.

1. A device for the tight, especially vacuum-tight closing of an aperture, in particular a slit-like or rectangular aperture with a length that is preferably a multiple of the width of the aperture, in particular for a lock arrangement of a vacuum treatment installation, said device having a closure member (2) and for said closure member a linear drive unit (3,4,5) which, by way of a translational movement, can move the closure member from an open position into a closed position, characterised in that the closure member has a sealing surface which is disposed in a plane (16) and which, in the closed position, makes sealing contact with a counter-sealing surface on the aperture side, said plane running transversely to the direction of translational movement (14) and at an oblique angle to the aperture normal (13).

2. The device of claim 1, characterised in that the device includes a counter-sealing-surface assembly (1) on which the counter-sealing surface is provided, said counter-sealing-surface assembly having a housing component that can be brought into close contact with the aperture via a contact surface (10), and having a channel (15) which, seen in cross-section parallel to the contact surface, has an aperture cross-section which is the same as or at least larger than said aperture.

3. The device according to claim 1 or 2, characterised in that the linear drive unit has at least one, preferably a plurality of lifting rods(s) distributed over the length of the closure member (2) to which the lifting rod(s) are attached at one of their ends, each lifting rod (7) being slidably mounted in a guide member (8) and each lifting rod having a flexible sealing member (6), in particular a diaphragm/bellows, mounted on it in a fixed position and sealed manner, especially in vacuum-tight manner, so that no abraded particles from the area of the guide element can get into the sealed-off area.

4. The device of claim 3, characterised in that the flexible sealing member (6) is mounted at its other end on a housing component (3) which can be brought into contact in sealed manner, especially vacuum-sealed manner, with a chamber wall.

5. The device according to one of the preceding claims, characterised in that the linear drive unit comprises at least one motor (5), in particular an electric motor, and at least one transmission (4), in particular a self-locking transmission.

6. The device according to one of the preceding claims, characterised in that the sealing surface and/or the counter-sealing surface is provided with sealing means (9), especially in the form of closed, circular O-rings that are preferably accommodated in corresponding grooves.

7. The device according to one of the preceding claims, characterised in that the plane (16) of the sealing surface is perpendicular to the direction of the translational movement (14).

8. The device according to one of the preceding claims, characterised in that the plane (16) of the sealing surface is inclined at an angle of 20° to 60°, in particular 25° to 45° to the aperture normal (13).

9. The device according to one of the preceding claims, characterised in that the length of the closure member (2) is greater than 1000 mm, in particular greater than 1500 mm.

10. A vacuum treatment installation with a plurality of successively arranged vacuum chambers that are interconnected via a slit-like aperture, so that plate-like substrates can be transported from one chamber to the next through the slit-like aperture, characterised by a device according to one of the claims 1 to 9.

11. The vacuum treatment installation according to claim 10 and claims 3 and 4, characterised in that with the exception of part of the lifting rod(s) (7), the linear drive unit is mounted outside the evacuated zone.

12. The vacuum treatment installation according to claim 10 or 11, characterised in that the substrate-transport direction is parallel to the aperture normal (13).
